(19) United States
(12) Patent Application Publication
(10) Pub. No.: US 2008/0270683 A1
(43) Pub. Date: Oct. 30, 2008

(54) SYSTEMS AND METHODS FOR A DRAM CONCURRENT REFRESH ENGINE WITH PROCESSOR INTERFACE

(75) Inventors: John E. Barth, Williston, VT (US); Richard E. Matick, Cortlandt Manor, NY (US); Stanley E. Schuster, Granite Springs, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/739,899

(22) Filed: Apr. 25, 2007

(51) Int. Cl. G06F 13/28

(52) U.S. Cl. 711/105

(57) ABSTRACT

Systems and methods for a DRAM concurrent refresh engine with processor interface. In exemplary embodiments, memory cells requiring periodic refresh at least once each for a specified refresh interval and words of an array organized banks in which the banks are selected for access by a bank-enable signal, each bank having a word decoder accepting one of two refresh word addresses, one refresh word address for a normal access, and the other for a refresh access, one of the word addresses selected by two separate enable signals, provided by on-macro refresh logic, which includes instructions to select one bank for refresh when no normal access occurs and select one bank for refresh concurrently with a normal access having no bank conflicts, the refresh logic maintaining the refresh status, timing of the refresh interval, and insuring all memory cells are refreshed within the refresh interval.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to dynamic random access memory (DRAM) and refresh engines, and particularly to systems and methods for a DRAM concurrent refresh engine with processor interface.

2. Description of Background

DRAM is a type of random access memory (RAM) that stores each bit of data in a separate capacitor within an integrated circuit. Since capacitors leak charge, the information eventually fades unless the capacitor charge is refreshed periodically. Since DRAM loses its data when the power supply is removed, it is in the class of volatile memory devices. DRAMs can also include an on-chip cache, thereby having a main memory portion and a cache memory portion. Such cache DRAMs can be implemented in low-end workstations and personal computers, as well as high-end systems as a secondary cache scheme. DRAM uses refresh circuitry for the purpose of maintaining the charge and thus information stored. If the refresh cycle is interrupted for any length of time, the information in the memory is lost. There persists a need for a fast DRAM cache having refresh that does not degrade performance of the DRAM.

### SUMMARY OF THE INVENTION

Exemplary embodiments include a memory array system having a memory and refresh engine, the system including memory cells requiring periodic refresh at least once each for a specified refresh interval and words of an array organized banks in which the banks are selected for access by a bank-enable signal, each bank having a word decoder accepting one of two refresh word addresses, wherein one refresh word address is for a normal access, and one refresh word address is for a refresh access, one of the two word addresses selected by two separate enable signals, the enable signals provided by on-macro refresh logic, wherein the on-macro refresh logic includes instructions to select one bank for refresh when no normal access occurs and select one bank for refresh concurrently with a normal access having no bank conflicts, the refresh logic maintaining the refresh status, timing of the refresh interval, and insuring all memory cells are refreshed within the refresh interval by providing a potential time out flag to a processor/memory controller to request inhibiting of further conflict accesses.

Additional embodiments include a method for managing refresh intervals in DRAM, the method including providing memory cells requiring periodic refresh at least once each for a specified refresh interval, organizing words within an array organized banks in which the banks are selected for access by a bank-enable signal, each bank having a word decoder accepting one of two refresh word addresses, wherein one refresh word address is for a normal access, and one refresh word address is for a refresh access, one of the two word addresses selected by two separate enable signals, the enable signals provided by on-macro refresh logic, selecting one bank for refresh when no normal access occurs and selecting one bank for refresh concurrently with a normal access having no bank conflicts, the refresh logic maintaining the refresh status, timing of the refresh interval, and insuring all memory cells are refreshed within the refresh interval by providing a potential time out flag to a processor/memory controller to request inhibiting of further conflict accesses.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which over a large percent of the DRAM accesses, allows refresh to occur simultaneously with a normal access, and does so with a very simple refresh engine and extremely simply interlace to the processor for controlling conflicts between normal accesses and a potential refresh period time-out.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates exemplary organization of a 2 Mbit eDRAM Macro with concurrent refresh;

FIG. 2 illustrates an exemplary high level view of bank refresh access versus normal access;

FIG. 3 illustrates priority/update logic for one refresh per cycle in accordance with exemplary embodiments;

FIG. 4 illustrates exemplary logic to control incrementing of RAC after all pBanks have been refreshed for the one word specified in RAC in accordance with exemplary embodiments;

FIG. 5 illustrates logic for initiation and full control of refresh interval of a FREE-Running refresh engine;

FIG. 6 illustrates an exemplary system for selectable mode implementations; and

FIG. 7 illustrates and exemplary system for CPU-Disabled refresh implementations.

The detailed description explains the preferred embodiments of the invention, together with advantages and features, by way of example with reference to the drawings.

### DETAILED DESCRIPTION OF THE INVENTION

Exemplary embodiments include concurrent refresh structure and logic for a 2 Mbit eDRAM macro. This macro contains all the refresh controls including the generation of an interrupt (Busy) signal sent back to the CPU/memory controller to stall any new normal accesses when refresh completion becomes imperative. This macro continuously attempts to refresh itself within any given, preset refresh time interval, T_{RI}, required for all bits to be refreshed. The macro also has controls to insure only the necessary number of one refresh per bit every full T_{RI}, thus avoiding any unnecessary refreshes, which waste power.

In one exemplary embodiment of this logic structure, and the resulting system requirements include one refresh and one normal access for each eDRAM cycle unless the two current pending refresh-banks are identical and coincide with normal access to same bank. In addition, refresh is free running under its own control and only does one refresh per word in the T_{RI} refresh time interval. For a pathological case of possible incomplete refresh within the T_{RI} time, the macro issues an INTERRUPT (Busy) signal back to the CPU in advance of the T_{RI} boundary and completes the refresh interval if the CPU/memory controller does not issue any more access requests. The refresh engine continues automatically and reset itself for each new refresh interval, T_{RI}. In general, no external control is needed except for start-up initialization of two counters and two shift registers. Refresh time, T_{RI}, can easily be changed, as well as the time of issue of the Interrupt signal within the T_{RI} interval. The system requirements for this exemplary embodiment include a CPU/memory controller that is able to halt normal accessing upon assertion of eDRAM Interrupt (Busy) signal.

In another exemplary embodiment, a selectable, multi-mode operation includes a refresh engine that has two modes, externally selectable by a single control bit. In one implementation, mode one is similar to the first mode described above. In another exemplary implementation, mode two includes a refresh cycle that can take place only when the CPU has asserted a separate input signal that allows refresh. The macro is now described in detail in the following discussion.

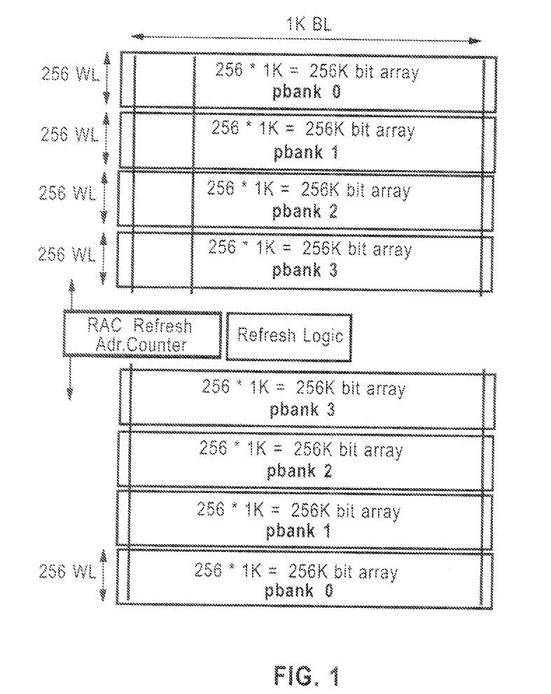

For ease of description, and only as an example, the concurrent refresh engine is described with respect to implementation in a 2 Mbit macro consisting of four separate, physical banks. The 2 Mbit macro can be constructed from the 1 Mbit macro shown in the top or bottom portion of FIG. 1. A physical bank, called pBank herein, includes 256 word lines with each word having 1K bits. In general, other values for the macro size and organization do not change the basic logic and architecture of this refresh engine. This macro is the basic unit that is refreshed, i.e. there are four pBanks so a total of 4×256=1K words are refreshed every T_{RI} sec. However, to obtain a 2 Mbit macro, two of these 1 Mbit units are placed together as shown in FIG. 1, and two pBanks are refreshed in parallel on each refresh cycle, i.e. the corresponding pBanks on the top and bottom half. For instance, if pBank 0 is selected, then the same word in the top and bottom pBank0 are simultaneously refreshed. Thus, while there are a total of eight pBanks, there are only four independent, logical banks in the 2 Mbit macro. Any number of such unit macros can be refreshed in parallel as dictated by the array and system architecture.

For a 2 Mbit Macro, four pBanks are on top and four are on bottom with REFRESH to 2 pBanks simultaneously, one on top and one on bottom. In addition, one RAC (Refresh Address Counter) for 2×4 pBanks is included. Bank selection enable for two shift registers as now discussed determine refresh. FU (shift Up) register A, and FD (shift Down) register, B, point to the next pBanks to be refreshed. The same RAC is used for the word, address of all pBanks. Register A or B is shifted after one word is refreshed in all banks. RAC is incremented +1 (or −1 as logic dictates) only after the same word in all banks have been refreshed and the shift occurs when position of register A=B as described below. It is possible to allow two refreshes per cycle (both A and B) if no conflict with a normal access.

For this 2 Mbit macro, each register, A & B needs four positions (one for each logical bank) since, on any array cycle, one can be stalled by a normal access and if is desirable for the other to be able to continue on one of the remaining pBanks.

A full, T_{RI} sec interval starts with RAC=0 and A & B in positions having maximum separation (e.g. A to left at position 0, B to right at position 3). Each time the word line pointed to by RAC is refreshed in the pBank pointed to by A, it is then shifted to A+1. Similarly, each time the same word line as per RAC and a different pBank pointed to by B, is refreshed, B is incremented to the next B−1 position.

When the two tokens (1's) in A and B completely circulate and come back together, and that position has also been refreshed, the refresh cycle is complete for the ONE word in RAC, so the RAC is Incremented by 1. After the first time A=B, 255 more word refresh cycles are performed, during which RAC increments from 0 to 255 (or 255 to 0). After this event occurs, the full array refresh operation has been completed and must have been done within T_{RI} sec. If the 2 Mbit macro has a cycle time of Ta sec., then since only 1K cycles (1K words=4 banks*256 words/bank) are needed for this full array refresh, this would take only Ta Ksec, if one bank refresh occurs every cycle. This scenario is possible if there are no bank refresh collisions with normal access demands. Even for most eases of some collisions, the refresh likely completes in less than T_{RI} since typically T_{RI}>>Ta. Thus, after all 1K words are refreshed, if the refresh logic just continued to operate, there could be excessive numbers of unnecessary refreshes, which consume excessive power. To prevent too many refreshes from being done, the RAC will have an Enable-Refresh bit, ER, which starts at 1, is used to enable refresh cycles, and is set to 0 when the RAC increments back to 0. A system clock which counts to T_{RI} is used to set this bit back to 1. Refresh can occur only when this Enable Refresh bit is set to 1.

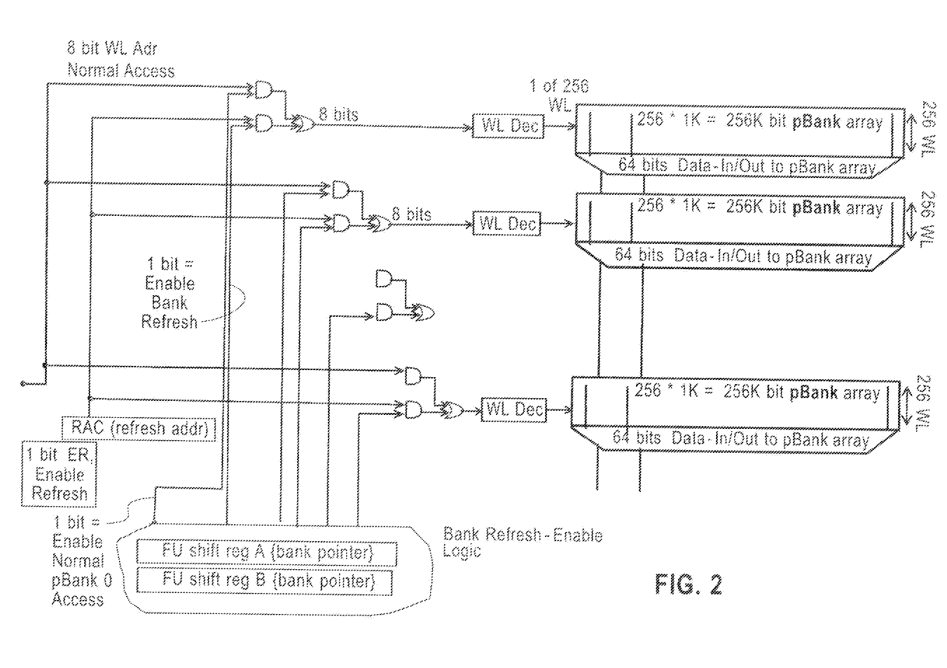

In a first scenario, with one refresh per cycle, the control functions are significantly simpler if only one bank is REFRESHED on any 1.3 cycle. Register A is given priority and is chosen, unless a collision occurs with a normal access, which causes B to be chosen. FIG. 2 shows selection and priority logic to achieve this scenario and is structured as now discussed. If no normal access is valid or if one is, and its bank address does not match the position pointed to by A, then the pBank pointed to by A is selected and B is suppressed. The A shift register is also shifted one position to the right. If the normal bank access collides with the bank pointed to by A, then B is selected and refreshed and the B shift register is shifted one place to the left (note A shifts 0, 1, 2, 3, 0, 1, 2, 3 etc., while B shift 3, 2, 1, 0, 3, 2, 1, 0, etc.) Thus, for each Ta sec, a refresh of one pBank occurs. A normal R/W may also take place concurrently (simultaneously, on same cycle) in any of the banks. A pathological condition can arise when A=B so that no refresh can take place for an excessive time period which could violate the T_{RI} sec refresh interval. This condition is discussed further in the description below.

On the next memory cycle, the above operations repeat but with either A or B pointing to a different pBank, using the same RAC address as previously. The operations continue for a total of four cycles (in the case of four logical banks), which refreshes the same word in each pBank. At this time, register A is aligned with B and this is used as the signal to increment RAC as described below. Additional details for this logic are now discussed.

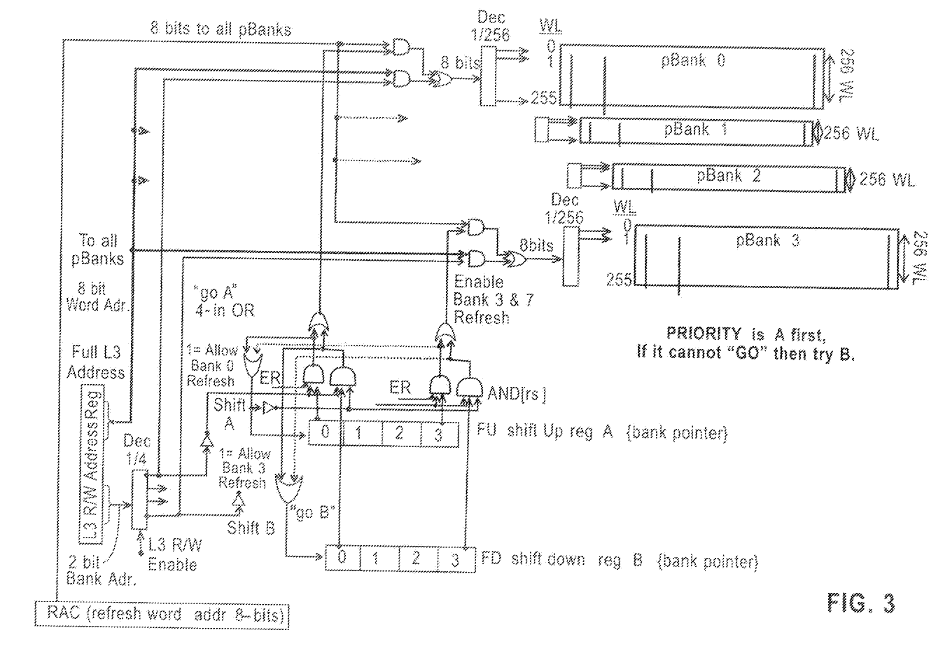

Referring to FIG. 3, it is possible that A does not equal B. At the beginning of a cycle, one a and one B register position gives a 1 output. Each of the four positions of these registers is enabled or disabled by a corresponding output of the one-out-of-four normal access-bank decoder. If the decoder selects bank 0, this disables the selection of a refresh token from position 0 of A or B by supplying a 0 input to the corresponding refresh select AND[rs]. There is one such AND for each position of both A and B. The output of each of these ANDs is input to a 2-in OR gate. There are four upward feeding OR gates, which select A or B for each bank enable position. There are only 2 downward facing ORs, “go-A” and “go-B”. One of these ORs together all four A outputs from the A position AND[rs] gates to provide the “Shift A” enable signal, while the other OR provides a corresponding function for the four B outputs as indicated. The output from the go-A OR gate is also inverted and serves as a 3^{rd} input to all four of the B position AND[rs] gates. This signal provides both the priority of A over B thereby preventing any B position from being selected if any A position is selected, and further allows position B to be refreshed if A has a collision. If any a position is 1, the go-A OR output is 1, which shifts register A, while its inverted signal will be a 0 input to the B position selection AND[rs] gates. If no A position AND[rs] is 1, the go-A OR output is 0, its inverse equals 1, which enables all B position AND[rs]. The B position with a 1 is thus selected for refresh.

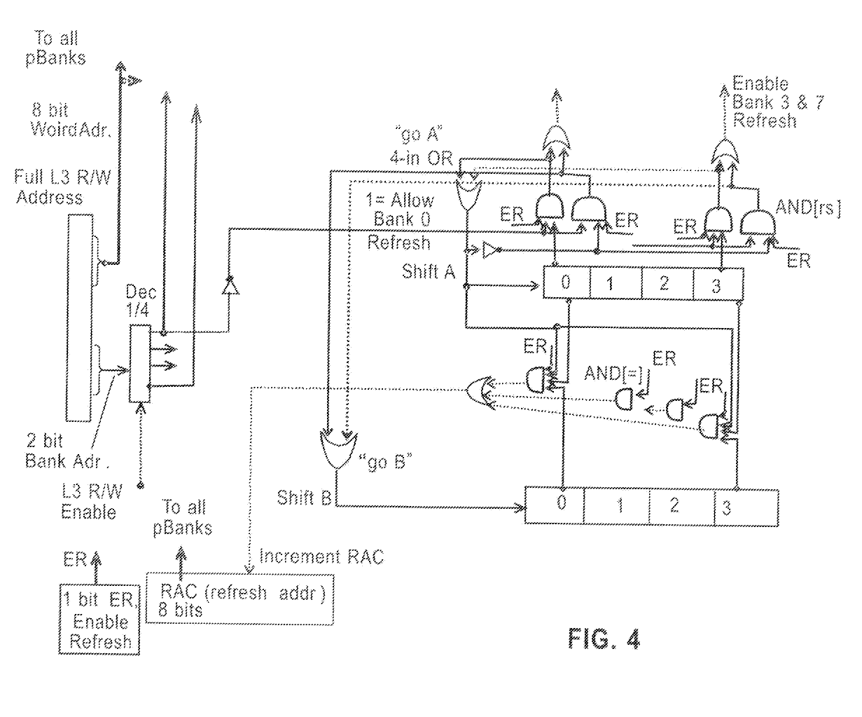

The logic for controlling the incrementing of the RAC is shown in FIG. 4. When A=B, if there is no conflict with the normal access, then this bank is refreshed and only A is shifted. Also, the RAC is incremented to the next word to be refreshed. A and B do not have to be reset to their initial position, since all banks are always refreshed as long as B starts with a position separation from A of {x[A]+(n−1)} mod n, for n banks, where the position numbering ranges from 0 to n−1 left to right for both A and B. These features insure that A and B point to all banks before aligning once again. A more detailed description of this logic is given next. For example, when A=B, A is selected for Refresh and A is shifted, B held fixed, and RAC is incremented +1. Then the entire refresh for next word across all banks can start again. A can start at any position x[A] so long as B starts at position (x[A]+3) mod 4, for four banks or in general, B must start at {x[A]+(N−1)] mod N for n banks.

As described above, RAC is incremented only after the word line specified by the current RAC is refreshed in all four logical banks. This condition occurs when A=B and is obtained as follows. Referring to FIG. 4, each of the four shift register positions has one AND[=] gate, which can have a 1 output only if the corresponding A and B positions are 1, and if the Shift-A signal is 1. The latter can be 1 only if the bank pointed to by A=B is allowed to refresh. Since A=B, the Shift-B signal is also 1, but only the A register should be shifted for this case. To prevent B from shifting, the Shift-B final input signal to register B is 1 only if Shift-B is 1 and if Increment RAC is 0. If A=B and a refresh is permitted. Increment RAC is 1, so its inverted signal to the final shift AND for B is 0, preventing B from shifting.

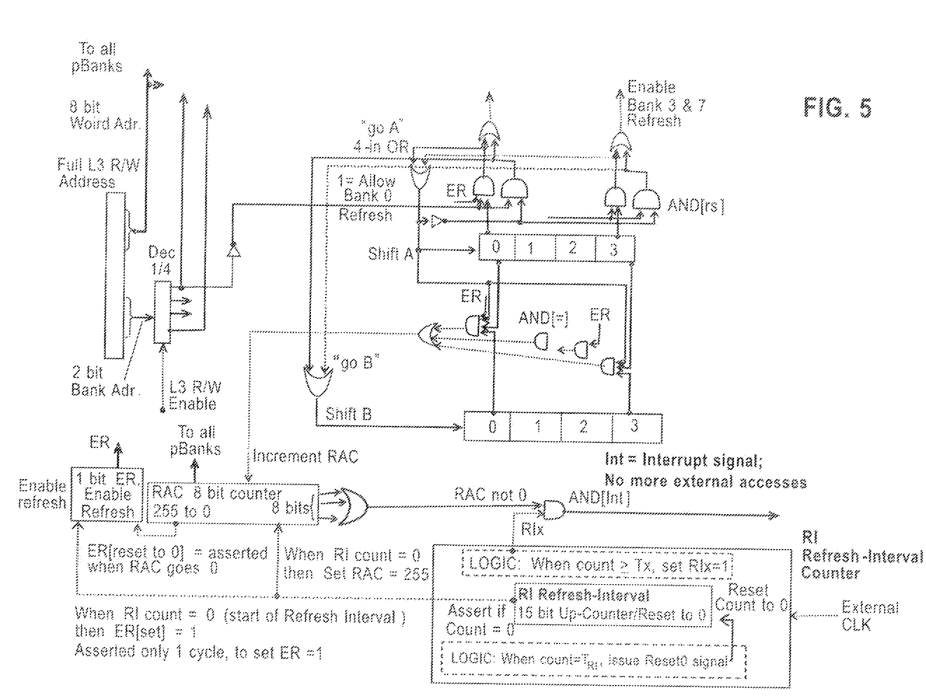

The logic for controlling the full refresh interval of T_{RI} sec. is shown in FIG. 5. In one example, the ER bit is set at beginning of 40 usec interval and reset to 0 when refresh is completed. The start of a new, T_{RI} sec. refresh interval occurs when the Enable Refresh latch, ER, is set to 1 by the Refresh Interval counter, RI, when its count=0. In general, the required 1K refresh cycles is completed long before the T_{RI} sec. have timed out. In such cases, RAC decrements to 0, which resets the ER latch to 0 as indicated. No further refresh cycles can take place until the T_{RI} sec counter has expired, and toggles back to 0, which subsequently sets ER back to 1.

As long as registers A and B do not point to the same logical bank, there is always one bank available for refresh, no matter what bank is accessed for a normal request. Even when A=B and has a collision with the normal access, there are often sufficient extra cycles for the refresh to be completed within T_{RI} sec. However, there are conditions for which the 1K word refresh cycles are not going to completion within the T_{RI} sec and require both detection and action. When A=B, there is only one logical bank available for refresh, and this can give rise to a pathological condition. If repeated, normal accesses occur to the same bank pointed to by A=B for many cycles, at some point normal accesses may cease and start a forced refresh. For example, if there are 100 words remaining to be refreshed in all four banks, a total remaining refresh requirement is 100×4×Ta sec/cycle=400×Ta sec. If the elapsed time since the start of the current T_{RI} refresh interval is T_{RI}=400 Ta, then there is only the exact number of cycles remaining for refresh if one refresh occurs each remaining cycle. Therefore, normal access is stalled and refresh goes to completion.

There are options during the T_{RI} refresh cycle in which a forced completion of the refresh or some portion of it can occur. In one option, a wait period is identified close to the T_{RI} limit and then cheek for a forced refresh. In one case, only three words would have been refreshed (A=B for RAC=0, and is pre empted by normal access) and the remaining time in the refresh interval is about 400 Ta. Thus, a forced refresh is necessary and for the last 400 Ta sec of the T_{RI} sec interval all pBanks are unavailable for normal, access, (i.e. the CPU would have to be able to tolerate a nearly 400 Ta sec lockout). This lockout time can be small, e.g. for Ta=4 or 2 ns, the lockout is 4 or 2 micro sec. respectively. In another option, the T_{RI} sec interval is divided into, say, P intervals and insists that 1024/P refreshes be completed in each smaller interval. Thus, if these have not been completed, the pBanks are unavailable for only a max of 400 Ta/F sec., which can be made small. However, any P>1 can introduce more total CPU lockouts than P=1 because some of the lockouts in smaller intervals have a high probability of completing and not being noticed in a larger time interval.

In the logic below, a T_{RI} sec interval is used fundamentally. T_{RI} sec is timed by an N_{RI} bit counter where N_{RI} is the upper integer value of: N_{RI}=log ₂[T_{RI}]=log ₁₉[T_{RI}]/log ₁₀[2]. Each tick of the clock, which increments this counter, is equal to the Ta sec. required for refresh. In the following discussions, each counter can be Up-counter (starting from 0, counting up) or Down-counter (starting from some preset count, and decrementing downward in count), which changes the logic slightly. In one implementation, the RAC is a down counter, which starts at 255 and is decremented (counts down) for each “increment” input signal. The refresh interval counter, RI can be an Up-counter, starting at 0 and counting up to a maximum possible count value and maximum time Tmax, respectively, of:

CountMax=2^{N}^{_{RI}}−1 Tmax=(2^{N}^{_{RI}}−1)T_{clk}.

However, since the given value of T_{RI} may be less than this Tmax., some logic is embedded within this counter macro, which provides a Reset-to-0 signal when, the counter reaches the given T_{RI} value. The setting and use of these counters is described in detail below.

A full T_{RI} sec refresh cycle begins when the RI counter toggles to 0. As a result, the refresh is enabled by setting latch ER=1 and the refresh engine runs unattended. At some time, Tx, before the end of the current refresh cycle, (i.e. as the RI counter nears the end of its interval cycle), a check is made, as described previously, to determine if the full refresh has been completed. If not, the Interrupt signal is asserted to insure full completion of the current refresh cycle. Tx is some pre-specified time, which is less than T_{RI} by at least the full time it would take to refresh the entire macro if no other accesses occurred, i.e. for the macro of FIG. 1, where, T_{RI}−Tx>1000 Ta.

In most cases, the refresh would have been completed lone before this Tx time is reached. When the count reaches the value of Tx, the signal, RI, is asserted to indicate this checkpoint has been reached. The “check” is, “Has RAC reached 0?” If it has, all the words have been refreshed in this interval. If RAC is not 0, there are remaining words to be refreshed. Thus for the rare cases when RAC is not 0 when RI=1, the Interrupt signal, Int, is set to 1 which is used by the CPU/memory controller to halt normal accesses. Now refresh automatically commences because there are no incoming collisions, and goes to completion indicated by RAC=0. At this point, the interrupt signal, Int is automatically reset to 0 by RAC=0, so the normal accesses can restart. In general, the CPU can be interrupted for the exact number of cycles required to complete the refresh.

Referring to FIG. 5, the RI Up-Counter (Refresh Interval) is a free-running counter, which is a timer from 0 to Tmax sec. When value of the counter is equal to or greater than Tx, the RIx input to the interrupt AND[Int] gate is 1. If any of the 8 bits in RAC are 1, then RAC is not 0. So the refresh has not been completed within the allotted time interval and second signal, RAC-not-0, to the AND[Int] is also 1, which generates an Interrupt signal back to the CPU/memory controller. Assuming normal L3 accesses then stop, the refresh logic automatically continues with refreshing the remaining banks until RAC is 0. When the latter occurs, signal RAC-not-0 becomes 0 so the interrupt signal becomes 0. The CPU can now resume normal accesses to L3. The Interrupt signal is asserted for the required remaining number of refresh cycles needed, so the CPU is interrupted for only the exact number of refresh cycles requires. Furthermore, when RAC goes to 0, ER is reset to 0 so no further refreshes are allowed since they are not needed, and no power is wasted. When Up-counter, RI, circulates back to 0, the RIx signal goes to 0 and the Enable-Refresh latch is set ER=1 which restarts the full refresh interval once again. The process is free running and requires no external controls in this simplified form. In an alternate exemplary embodiment, the timing interval for testing if refresh is completed can be broken into a larger number, P, of smaller intervals as discussed above. This embodiment might be desirable if, for instance, the system can only tolerate a maximum continuous interrupt of T_{RI}/P sec., where P>1.

The processor cycle time is at least 2× or more times as fast as the eDRAM cycle time. As a result, with a free-running refresh engine, it is possible that a CPU access request arrives on a boundary that occurs at the mid point of an on-going refresh cycle. In such cases, the processor waits additional cycles for the DRAM to be available and reload to start. For high-end systems, such an extra delay is either undesirable or unacceptable. This can be avoided by not using a free-running refresh engine but rather let the CPU provide a control signal to allow refresh cycles to proceed.

In an exemplary embodiment, the CPU/controller provides a CPU Enabled Refresh, CER, signal each cycle, which indicates that a new refresh cycle can proceed. In such a case, the refresh engine distributes an Enable Refresh signal at the beginning of each such cycle, and lasts for only one cycle. The remainder of the logic remains essentially unchanged. Only the turning on and off of ER is different from that in the free-running refresh logic

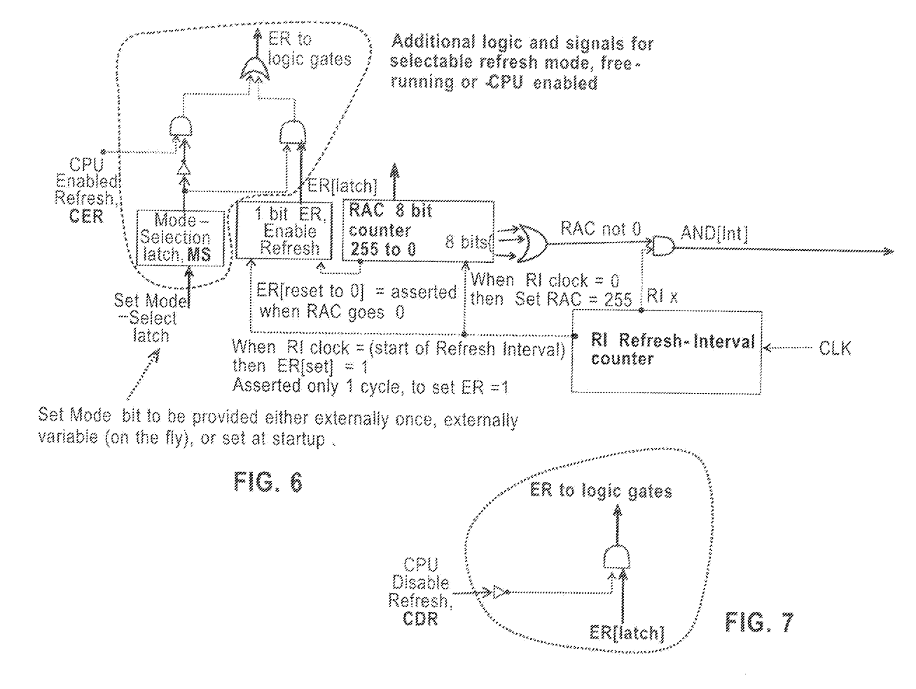

A fast eDRAM macro with only CPU controlled refresh is likely to be unsuitable for low and mid range systems. It is possible to have a single DRAM refresh design. In an exemplary embodiment, an Enable Refresh signal to allow or prevent refresh on any cycle can be implemented. For example, one system is a multi-mode refresh engine in which either a free-running mode or a CPU controlled mode is initialized on the macro and it continues in that mode until reset. The resetting can be done at start-up time, or it can he done dynamically, on the fly. Such a system is shown in FIG 6.

An additional system is shown in FIG. 7, that is, a CPU-Disabled-Refresh. Simplified refresh logic allows the CPU to inhibit free-running refresh in anticipation of a possible additional boundary delay. In such a design, the refresh engine runs in free-mode until the CPU issues an external signal, which stops the refresh completely when the CPU anticipates a possible additional boundary delay, which is intolerable for an upcoming access. This signal is generated Nd cycle in advance of the actual access, otherwise it is useless, where Nd is the number of DRAM cycles (measured in # processor cycles) for access. In exemplary implementation, both a free-running mode and CPU controlled mode can be run as shown in FIG. 6. In such a case, an additional Mode Selection, MS, signal is available each cycle, which determines the source of the ER bit. This ER bit comes either from the free-running ER latch or the external CPU Enable Refresh pin. In an alternate exemplary implementation, Refresh is free-running unless the CPU provides an external signal, CPU Disabled Refresh, CDR. This condition is Nd cycles ahead of an actual CPU initiated access in order to avoid a possible additional boundary wait time. In this case, all refreshes occur only in free-running mode. The CPU signal only prevents such a refresh when it anticipates a possible additional boundary delay for an upcoming refresh.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A memory array system having a memory and refresh engine, the system composing:
memory cells requiring periodic refresh at least once each, for a specified refresh interval; and
words of an array organized banks in which the banks are selected for access by a bank-enable signal, each bank having a word decoder accepting one of two refresh word addresses, wherein one refresh word address Is for a normal access, and one refresh word address is for a refresh access, one of the two word addresses selected by two separate enable signals, the enable signals provided by on-macro refresh logic;
wherein the on-macro refresh logic includes instructions to;
select one bank for refresh when no normal access occurs; and
select one bank for refresh concurrently with a normal access having no bank conflicts, the refresh logic maintaining the refresh status, timing of the refresh interval, and insuring all memory cells are refreshed within the refresh interval by providing a potential time out flag to a processor/memory controller to request inhibiting of further conflict accesses.

2. The system as claimed in claim 1 wherein the refresh word addresses are maintained by the refresh engine in one refresh address counter, being at least one of an up-counter and set to 0 and a down counter, set at a maximum word value, at the start of each refresh interval, the same word in all banks being refreshed prior to at least one of incrementing and decrementing the refresh word addresses, the completion of the refresh interval being signaled by the word address reaching maximum value and switching back to 0.

3. The system as claimed in claim 2 wherein the refresh interval is maintained in a refresh interval counter, the counter being at least one of an up-counter, and a down counter, set to at least one of 0 and maximum value at the beginning of each refresh interval, the refresh interval ending when the count reaches a value equivalent to the given, specified maximum time between refreshes, a second potential time out signal asserted if the RI counter reaches a count equivalent to a time which is refresh interval minus the total time to refresh all words, provided the refresh address counter is less than its maximum value, the potential time out signal resetting if the refresh address counter subsequently completes its cycle for the current refresh interval, the potential time out signal being used by the processor/memory controller to at least one of stop and limit normal memory accesses.

4. The system as claimed in claim 1 wherein a cycle time of the memory is at least two times longer than a cycle time of a maximum possible normal access requests.

5. The system as claimed in claim 4 further comprising a concurrent refresh engine in which there are two modes of operation that are dynamically selectable by one mode bit, a first mode in which the refresh engine includes logic for maintaining state and running a refresh operation, and a second mode in which the CPU/memory controller takes charge of the timing of the issuing of refresh operations for normal accesses to commence on a memory one-half cycle point, the second mode continuing as long as the mode select signal is asserted for the second mode, and can be reset back to the first mode by the processor/memory controller.

6. The system as claimed in claim 1 wherein the selected refresh bank and word refresh addresses are generated within the memory macro, for which the control, updating, and timing of refresh accesses is fully maintained within the processor/memory controller.

7. A method for managing refresh intervals in DRAM, the method comprising:
providing memory cells requiring periodic refresh at least once each for a specified refresh interval;
organizing words within, an array organized banks in which the banks are selected for access by a bank-enable signal, each bank having a word decoder accepting one of two word addresses, wherein one word address is for a normal access, and one word address is for a refresh access, one of the two word addresses selected by two separate enable signals, the enable signals provided by on-macro refresh logic;
selecting one bank for refresh when no normal access occurs; and
selecting one bank for refresh concurrently with a normal access having no bank conflicts, the refresh logic maintaining the refresh status, timing of the refresh interval, and insuring all memory cells are refreshed within the refresh interval by providing a potential time out flag to a processor/memory controller to request inhibiting of further conflict accesses.

8. The method as claimed in claim 7 further comprising generating the selected refresh bank and word refresh addresses within the memory macro, for which the control, updating, and timing of refresh accesses is folly maintained within the processor/memory controller.
